(19) United States
(12) Patent Application Publication
(10) Pub. No.: US 2010/0083319 A1
(43) Pub. Date: Apr. 1, 2010

(54) METHODS AND APPARATUS FOR LOCATING CONTENT IN AN ELECTRONIC PROGRAMMING GUIDE

(75) Inventors: Henry Gregg Martch, Parker, CO (US); Matthew Coburn, Denver, CO (US)

Correspondence Address: EchoStar Technologies, L.L.C.;Legal Department, 9601 SOUTH MERIDIAN BOULEVARD, ENGLEWOOD, CO, 80112, US

(73) Assignee: EchoStar Technologies LLC, Englewood, CO (US)

(21) Appl. No.: 12/242,614

(22) Filed: Sep. 30, 2008

(51) Int. Cl. H04N 5/445

(52) U.S. Cl. 725/53

(57) ABSTRACT

The various embodiments described herein facilitate the identification of television content related to a specific search descriptor and genre. A user provides input requesting to locate television content related to a particular search descriptor and genre. A search keyword is identified based on the search descriptor and a search of an electronic programming guide is performed based on the search keyword to generate intermediate search results of television events related to the search descriptor. A filtering operation is performed on the intermediate search results using one or more filters identified based on the programming genre to generate final search results. The final search results thus include content that both matches the search keyword and has characteristics of the programming genre of content requested by the user.

### BACKGROUND

Electronic program guides are utilized in association with televisions and television receivers to allow users to locate television programs of interest for viewing and/or recording. Many electronic programming guides include search features for locating content matching specified user supplied criteria. For example, a user may supply the search term Seinfeld to locate episodes of the television program in the electronic programming guide. Television events matching the search term are identified and displayed to the user. If the electronic programming guide is associated with a digital video recorder (DVR), then some or all of the identified television events may be recorded for subsequent viewing by the user.

One problem with electronic programming guides is that they are typically inefficient for locating sports programming. The descriptive information regarding sports programming is not uniform, and thus, content associated with a particular team may be labeled many different ways in the electronic programming guide. For example, a football game involving the Chicago Bears vs. the Detroit Lions may be labeled in the electronic programming guide as “Chicago vs. Detroit”, “Lions vs. Bears”, “Chicago Bears vs. Detroit Lions” or “NFL Football Game”. Additionally, a search for a sporting event may locate other unwanted but related shows, such as pre-game shows, post-game shows, talk shows and the like. Thus, a user searching an electronic programming guide for upcoming televised Chicago Bears football games may be unsuccessful in locating the aforementioned game using the search term “Chicago Bears”. However, a search using the term “Bears” may also be inadequate, as the search may identify an abundance of non-football programming, such as television shows about polar bears, the Care Bears or the movie The Bad News Bears, and the user may become frustrated by the amount of programming identified responsive to their search. Thus, it is a problem that electronic programming guides do not allow users to easily identify programming related to a particular sports team.

### BRIEF DESCRIPTION OF THE DRAWINGS

The same number represents the same element or same type of element in all drawings.

FIG. 1 illustrates an embodiment of an entertainment system.

FIG. 2 illustrates an embodiment of a television receiver of FIG. 1.

FIG. 3 illustrates a screenshot of an embodiment of a search menu outputted by the television receiver of FIG. 2.

FIG. 4 illustrates a screenshot of an embodiment of a search result menu.

FIG. 5 illustrates a screenshot of an embodiment of a sport selection menu outputted by the television receiver of FIG. 2.

FIG. 6 illustrates a screenshot of an embodiment of a team selection menu outputted by the television receiver of FIG. 2.

FIG. 7 illustrates a screenshot of an embodiment of a search result menu outputted by the television receiver of FIG. 2.

FIG. 8 illustrates an embodiment of a process for locating television content.

### DETAILED DESCRIPTION

The various embodiments described herein generally provide apparatus, systems and methods which facilitate the identification of television content in an electronic programming guide. More particularly, the various embodiments described herein facilitate the identification of television content related to a specific search descriptor and genre. A user provides input requesting to locate television content related to a particular search descriptor and genre. A search keyword is identified based on the search descriptor and a search of an electronic programming guide is performed based on the search keyword to generate intermediate search results of television events related to the search descriptor. A subsequent filtering operation is performed on the intermediate search results using one or more filters identified based on the programming genre to generate final search results. The final search results thus include content that both matches the search keyword and has characteristics of the programming genre of content requested by the user.

In at least one embodiment, the keyword is utilized to search descriptive information of the electronic programming guide. Descriptive information includes a title, description or other type of metadata (e.g., actor information) that describes the substance of the television event. For example, a search of the titles and descriptions of the electronic programming guide may be performed to locate television events corresponding to the search keyword. The television events corresponding to the search keyword form intermediate search results, which may include television events that are both related and unrelated to the genre of television content requested by the user.

The intermediate search results are filtered to narrow the final search results to a particular genre of television content requested by the user. In at least one embodiment, filtering operations are applied to non-descriptive program information associated with the intermediate search results to narrow the results to the genre of content requested by the user. Non-descriptive program information includes any type of information that describes other aspects of a television event besides the substance of the television content. For example, non-descriptive program information may include the broadcast channel of the television event, the broadcast time of the television event, the broadcast date of the television event and the length of the television event.

Filters are identified based on the genre of the television programming, such as the channels that would be expected to carry the particular genre of television content or the expected broadcast dates and times of the particular genre of television content. The embodiments described herein leverage the fact that particular genres of content often share similar characteristics. For example, football programming is typically broadcast on certain channels such as ESPN, NBC, ABC and the NFL Network. Conversely, football programming is not broadcast on particular channels, such as the Cartoon Network or the Discovery Channel. Similarly, one would expect football programming, especially live football games, to be shown on particular days and times (e.g., Sunday afternoons or Monday evenings). These characteristics are utilized in various embodiments described herein to further narrow the search results to identify programming requested by the user.

The television events in the intermediate search results are checked to determine whether the associated non-descriptive programming information corresponds within the identified filters. If a television event does not correspond with the identified filters, then the television event may be removed from the search results. For example, if the genre of television content is typically expected to be broadcast on Sunday afternoons, and an identified television event is to be broadcast during the middle of the night on a Wednesday, then the identified television event may be removed from the search results during the filtering process. The filtered search results are then displayed to a user for review. In at least one embodiment, the filtered search results may be optionally utilized to identify recording timers for recording of the identified television events.

Particular programming may also be located using other techniques. In one technique, an electronic programming guide (EPG) provider may include flags that indicate whether an event is a specific type of programming. For example, EPG events may include a game flag to indicate that particular content is a game event. An electronic programming guide then may filter search results based on the game flag and/or other data to locate game events related to a particular team. In other techniques, the search process may be simplified if game events are consistently titled. However, techniques described below are operative to locate programming when flags and consistent titling are not available in the EPG or as a cost effective alternative to avoid paying an EPG data provider for these additional data descriptors.

The embodiments described herein are particularly useful for identifying sports genre programming, and more particularly, identifying television content related to a particular sports team. Thus, the embodiments will be described in the context of locating sports programming related to a particular team. However, it is to be appreciated that the embodiments described herein may also be applied to identify other genres of television content, such as children's programming, religious programming, soap operas, court television programming, nature programming or any other genre of programming that may be filtered based on identified rules as described in further detail below.

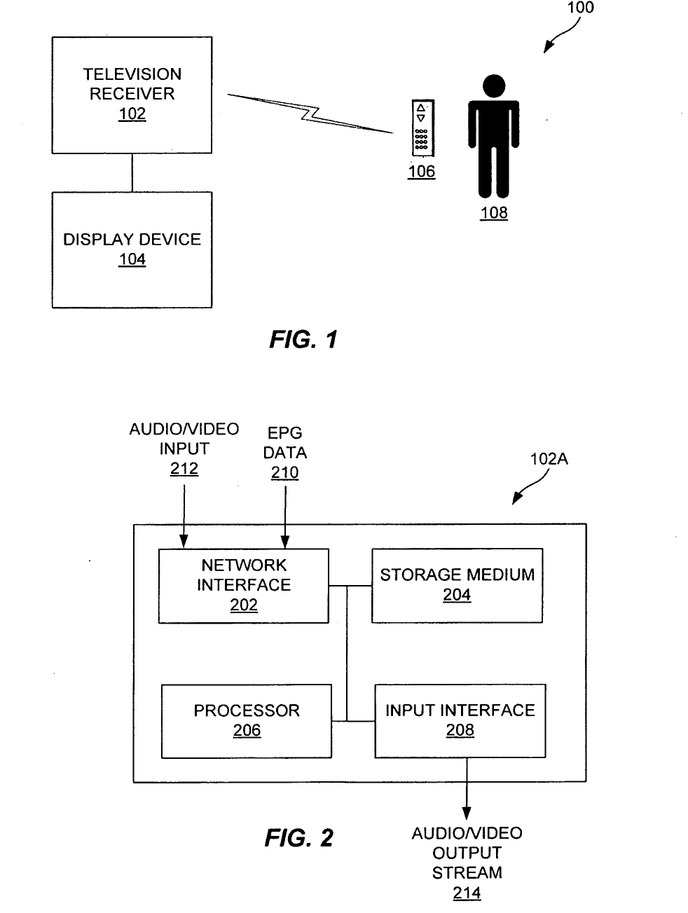

FIG. 1 illustrates an embodiment of an entertainment system 100. The entertainment system 100 presents content to a user 108. In at least one embodiment, the content presented to the user 108 includes an audio/video stream, such as a television program, movie or other recorded content and the like. The entertainment system 100 further facilitates the searching and identification of content related to a user query. The entertainment system 100 includes a television receiver 102, a display device 104 and a remote control 106. Each of these components is discussed in greater detail below. The entertainment system 100 may include other devices, components or elements not illustrated for the sake of brevity.

The television receiver 102 is operable to receive content from one or more content sources (not shown in FIG. 1) and output the received content for presentation by the display device 104. More particularly, the television receiver 102 is operable to receive, demodulate and output a television signal from a programming source, such as a satellite, cable, internet, terrestrial or other type of television transmission signal. The television receiver 102 may receive an audio/video stream in any format (e.g., analog or digital format). Likewise, the television receiver 102 may output the audio/video stream for presentation by the display device 104 in any type of format. In at least one embodiment, the television receiver 102 is a set-top box (e.g., a satellite or cable television receiver or converter box) or other similar device that processes and provides one or more audio and/or video output streams to the display device 104 for presentation to the user 108.

The television receiver 102 is further configured to output for display menus and other information that allow a user 108 to control the selection and output of content by the television receiver 102. For example, as described in further detail below, the television receiver 102 outputs electronic programming guide menus for review by the user 108. At least one of the electronic programming guide menus allows the user 108 to search for content related to a particular search descriptor and genre. For example, as described in further detail below, the user 108 may desire to search for television content related to a particular sports team.

The television receiver 102 operates to receive user input from the user 108 requesting to locate specified television content related to the sports team. The television receiver 102 performs the searching and filtering operations below to locate television events in the electronic programming guide that relate to the specified team and outputs the results of the searching and filtering operations for display by the display device 104. In at least one embodiment, the television receiver 102 includes an integrated DVR operable to record video signals, corresponding with particular television programs, for subsequent viewing by the user 108.

The display device 104 may comprise any type of device capable of receiving and outputting a video signal in any format. Exemplary embodiments of the display device 104 include a television, a computer monitor, a liquid crystal display (LCD) screen, a touch screen and a projector. The display device 104 and the television receiver 102 may be communicatively coupled through any type of wired or wireless interface. For example, the display device 104 may be communicatively coupled to the television receiver 102 through a coaxial cable, component or composite video cables, an HDMI cable, a VGA or SVGA cable, a Bluetooth or WiFi wireless connection or the like. In at least one embodiment, the television receiver 102 and the display device 104 may be integrated as a device combining the functionality of a display device and a television receiver.

The remote control 106 may comprise any system or apparatus configured to remotely control the output of content by the television receiver 102. The remote control 106 may minimally include a transmitter, an input device (e.g., a keypad and/or touch pad) and a processor for controlling the operation of the remote control 106. The remote control 106 may communicate commands to the television receiver 102 requesting to playback content, temporally move through content (e.g., fast-forward or reverse), adjust the volume, access and/or search an electronic programming guide, set or edit recording timers and the like. In some embodiments, the remote control 106 may additionally be configured to remotely control the display device 104. The remote control 106 may communicate with the television receiver 102 and/or the display device 104 through any type of wireless communication medium, such as infrared (IR) signals or radio-frequency (RF) signals.

The remote control 106 may include any type of man-machine interface for receiving input from the user 108. For example, the remote control 106 may include buttons for receiving input from the user 108. In at least one embodiment, the remote control 106 includes a touch pad for receiving input from the user 108. The remote control 106 may further include a trigger, utilized in association with the touch pad, for allowing the user 108 to input information associated with the menus displayed on-screen.

FIG. 2 illustrates an embodiment of a television receiver of FIG. 1. FIG. 2 will be discussed in reference to the entertainment system 100 illustrated in FIG. 1. The television receiver 102A includes a network interface 202, a storage medium 204, a processor 206 and an input interface 208. Each of these components will be discussed in greater detail below. The television receiver 102A may include other elements, components or devices which are not illustrated for the sake of brevity.

The network interface 202 is operable to receive electronic programming guide (EPG) data 210 from a content source. The network interface 202 may receive the EPG data 210 from any content source using any type of communication medium. In at least one embodiment, the network interface 202 receives the EPG data 210 from a television programming source, such as through an over-the-air broadcast signal, a direct broadcast satellite signal, a cable television signal or an internet protocol television (IPTV) signal. The network interface 202 provides the EPG data 210 to the processor 206 for further utilization. In some embodiments, the network interface 202 may query a content source for the EPG data responsive to input from the user 108 (see FIG. 1). In at least one embodiment, the network interface 202 may periodically receive updated EPG data 210 and store the same to the storage medium 204 for subsequent utilization by the processor 206. For example, the storage medium 204 may store 7 days worth of EPG data such that the user 108 may browse for programming to view up to a week in advance.

In at least one embodiment, the network interface 202 may additionally receive an audio/video input 212, e.g., a television broadcast signal, from the content source. More particularly, the network interface 202 receives and tunes a television signal including television programming. The network interface 202 may receive an over-the-air broadcast, a direct broadcast satellite signal, a cable television signal or an internet protocol television (IPTV) signal and tune the audio/video input 212 to extract the selected television programming. In other words, the network interface 202 may be embodied as a television tuner. In at least one embodiment, the television receiver 102A may include multiple tuners, utilized by the user 108 to view and/or record multiple television programs simultaneously.

The network interface 202 may alternatively be a separate component from the television tuner. For example, the network interface 202 may comprise an Ethernet port operable to download EPG data 210 from the Internet or another type of data network. Additionally, the television receiver 102A may include a separate satellite television tuner operable to receive and demodulate the audio/video input 212 from a satellite broadcast source.

The storage medium 204 is operable to store electronic programming guide data and other system information utilized by the television receiver 102A. The storage medium 204 may comprise any type of non-volatile memory appropriate for storing data utilized by the television receiver 102A. Exemplary storage mediums 204 include semi-conductor memory, hard drives (e.g., magnetic memory) and flash memory. In some embodiments, the television receiver 102A may optionally include DVR functionality to record and persistently store video signals received by the television receiver 102A. Thus, the storage medium 204 may include an appropriate amount of capacity for the short-term or long-term storage of video signals. For example, the storage medium 204 may include a hard drive for storing video signals. In some embodiments, a hard drive or other storage medium may be internally located within the television receiver 102A. In other embodiments, a hard drive or other storage medium may be located external with respect to the television receiver 102A. The television receiver 102A may also utilize a combination of internal and external storage mediums 204 for storage of video signals and other data.

The processor 206 is operable to control the operation of the television receiver 102A. The processor 206 may be a single processing device or a plurality of processing devices that cooperatively operate to control the operation of the television receiver 102A. The processor 206 may include various components or modules for processing and outputting audio/video content. Exemplary components or modules for processing audio/video content include a demodulator, a decoder, a decompressor, a conditional access module and a transcoder module.

The processor 206 is operable to receive the audio/video input 212, received in at least one embodiment via the network interface 202, and generate an audio/video output stream 214 based on the audio/video input 212 for display by an associated display device 104. The processor 206 may incorporate circuitry to output the audio/video streams in any format recognizable by the display device 104, including composite video, component video, Digital Visual Interface (DVI) and High-Definition Multimedia Interface (HDMI). The processor 206 may also incorporate circuitry to support multiple types of these or other audio/video formats. In at least one embodiment, as described above, the television receiver 102A may be integrated with the display device 104, and the processor 206 may be operable to control the presentation of the audio/video output stream 214.

In at least one embodiment, the processor 206 is operable to coordinate storage of the audio/video input 212 onto the storage medium 204. The processor 206 is also operable to retrieve stored video content to generate the audio/video output stream 214 for display by the display device 104. To coordinate the storage of the audio/video input 212, the processor 206 is operable to receive user input requesting to record one or more television programs. Responsive to the user input, the processor 206 sets recording timers for the indicated television programs. The indicated television programs are thus recorded responsive to the recording timers. The processor 206 is also operable to generate and output various menus, such as electronic programming guide menus and search menus based on various input. The generation and output of the menus by the processor 206 is discussed in greater detail below.

The input interface 208 is operable to wirelessly receive data from the remote control 106. The input interface 208 may communicate with the remote control 106 utilizing any type of IR or RF communication link. In at least one embodiment, the input interface 208 receives a key code from the remote control 106, and responsively provides the key code to the processor 206. In some embodiments, the input interface 208 may receive positional information from a scrolling device of the remote control 106, e.g., a touch pad, scroll wheel or the like. Some of the data received by the input interface 208 may request to view and/or search electronic programming guide data and the like.

Responsive to user input requesting to view an electronic programming guide, the processor 206 generates an electronic programming guide menu based on the EPG data 210 and outputs the electronic programming guide menu in the audio/video output stream 214. The user 108 may further provide input requesting to search for content within the electronic programming guide. The processor 206 responsively outputs a search menu to facilitate the receipt of search criteria from the user 108 (sec FIG. 1). The search menu is outputted in the audio/video output stream 214 for display by the display device 104.

The search menu facilitates the receipt by the processor 206 of any type of search criteria from the user 108. More particularly, the search menu allows the user 108 to input a request to locate particular television content related to both a particular search descriptor and genre. For example, a search descriptor may comprise the name of a particular sports team. Similarly, the genre may indicate the sport of the aforementioned sports team. Further search criteria may also be provided to differentiate between new or recent games for the sport teams, non-game related content for the sports team and older historic games for the sports team (like that shown on NFL Classics). In at least one embodiment, the search menu allows the user to manually input the search criteria.

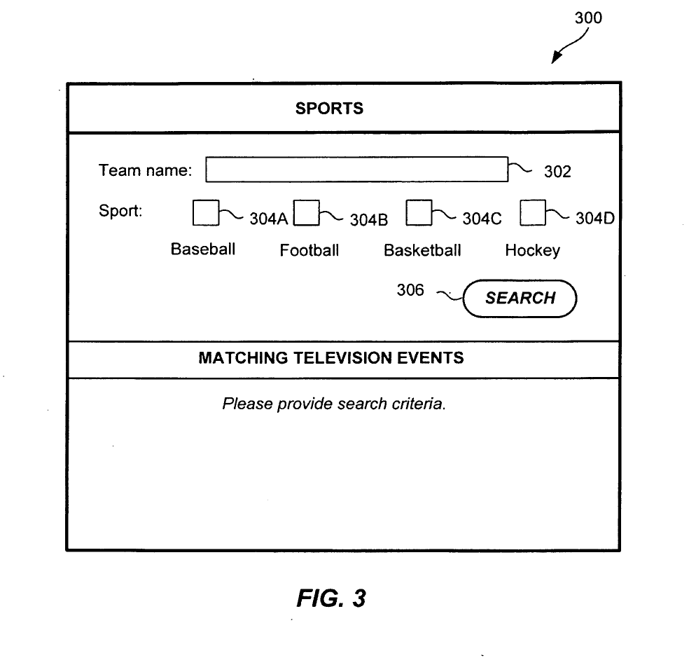

FIG. 3 illustrates a screenshot of an embodiment of a search menu 300 outputted by the television receiver 102A of FIG. 2. The search menu 300 includes a text input field 302 configured to receive a search descriptor from the user 108 (see FIG. 1). The search menu 300 further includes multiple checkboxes 302A-304D that allow the user 108 to provide a search genre for their query. In the illustrated embodiment, the search genres include various sports searchable in an electronic programming guide using the search menu 300. The user 108 activates one of the checkboxes 304A-304D to indicate the desired genre search criteria. Upon actuation of the search button 306, the processor 206 initiates a search of an electronic programming guide for television content matching the search criteria provided by the user 108.

For example, the user 108 may desire to locate programming related to the Chicago Bears football team. The user 108 enters the team name “Chicago Bears” into the text input field 302, activates the checkbox 304B and actuates the search button 306 to begin the search. The processor 206 is responsively operable to identify a search keyword based on the search descriptor provided by the user 108. The search keyword may include all of the search descriptor or any portion thereof. For example, if the search descriptor comprises “Chicago Bears”, then the search keyword may comprise “Chicago”, “Bears”, “Chicago Bears” or any subset of the aforementioned terms.

After identifying the search keyword, the processor 206 is operable to perform a search of an electronic programming guide based on the search keyword. For example, the processor 206 may search titles and descriptions in the electronic programming guide that include the term “Bears”. The search of the electronic programming guide identifies television events that match the search keyword, which are herein referred to as the intermediate search results. The intermediate search results may include a combination of snorts and non-sports programming depending on the particular search keyword utilized. Illustrated in Table #1 is one embodiment of the intermediate search results for the keyword “Bears”.

TABLE #1
Intermediate search results for “Bears”

| Television Event | Channel | Date | Time |
|---|---|---|---|
| Chicago Bears at Detroit Lions | NBC | Sun-14 | 2:15 P.M. |
| The Care Bears | Toon | Mon-15 | 9:00 A.M. |
| Bears in nature | Discovery | Mon-15 | 7:00 P.M. |
| Bears Rap-Up with Coach XXX. | Local NBC | Mon-15 | 10:00 PM |
| Chicago Bears at Detroit Lions | NBC | Tue-16 | 1:15 A.M. |
| (R) | | | |
| The 1985 Chicago Bears | NFL Network | Tue-17 | 1:00 A.M. |
| The Care Bears | Toon | Tues-17 | 9:00 A.M. |
| The Care Bears | Toon | Wed-17 | 9:00 A.M. |
| Bears in nature | Discovery | Wed-17 | 7:00 P.M. |
| The Care Bears | Toon | Thu-17 | 9:00 A.M. |
| The Bad News Bears | Cinemax | Thu-19 | 2:00 P.M. |
| The Care Bears | Toon | Fri-17 | 9:00 A.M. |
| The Majestic Grizzly Bear | PBS | Fri-19 | 6:00 P.M. |
| NFL - Vikings at Bears | ESPN | Sun-21 | 7:00 P.M. |

As illustrated in Table #1, some of the programming included in the intermediate search results includes television events related to the Chicago Bears football team. However, other identified content includes television events unrelated to the Chicago Bears football team. To narrow the intermediate search results listed in Table #1 to include just the sports programming requested by the user 108, the processor 206 identifies one or more filters for application to the intermediate search results based on the genre indicated in the search menu 300. In other words, in the illustrated example, the processor 206 identifies one or more filters applicable for identifying football content.

In at least one embodiment, the filters are applied to non-descriptive program information of the intermediate search results. For example, the non-descriptive information may include channels, broadcast times, broadcast dates and the like of the television events identified in the intermediate search results. Thus, exemplary filters applied to the television events of the intermediate search results may include expected broadcast times, expected broadcast channels and expected broadcast dates for sports related programming.

In at least one embodiment, the filters may be pre-defined for particular genres. Still further, the filters may be pre-defined for particular search descriptors (e.g., the descriptor Chicago Bears may be associated with different filters than the search descriptor Detroit Lions). For example, different team's games may be typically broadcast shown on different channels. Thus, the television receiver 102A may store a database of filters associated with particular search descriptors inputted by the user 108.

In at least one embodiment, the filters may be defined based upon user provided input. For example, the search menu 300 may include input fields for designating the filters utilized by the processor 206. Channel designations, broadcast dates and broadcast times are exemplary input fields that may be included in the search menu 300 for the user 108 to input filter information to the television receiver 102A. It is to be appreciated that any combination of system-defined and user-defined filters may be used depending on desired design criteria.

Take for example the scenario where the processor 206 utilizes filters that are pre-defined to identify football programming. For example, one filter may indicate that football programming it typically shown on the NBC, ESPN and NFL Network channels. Thus, programming broadcast on other channels is considered unrelated to football programming based on the application of this particular channel filter. If a channel filter is applied to the intermediate search results in Table #1, then television events which are not shown on one of the channels indicated by the channel filter will be removed from the intermediate search results. The remaining television events after application of the filter form the final search results outputted for display by the processor 206. Table #2 illustrates an embodiment of final search results generated by the processor 206 after application of the channel filter.

TABLE #2
Final search results

| Television Event | Channel | Date | Time |
|---|---|---|---|
| Chicago Bears at Detroit Lions | NBC | Sun-14 | 2:15 P.M. |
| Bears Rap-Up with Coach XXX. | Local NBC | Mon-15 | 10:00 PM |
| Chicago Bears at Detroit Lions | NBC | Tue-16 | 1:15 A.M. |
| (R) | | | |
| The 1985 Chicago Bears | NFL Network | Tue-17 | 1:00 A.M. |
| NFL - Vikings at Bears | ESPN | Sun-21 | 7:00 P.M. |

As illustrated in FIG. 2, the non-football programming has been eliminated from the final search results by the processor 206. Thus, the user 108 is presented with a list of television events that do not include anything except television events associated with the Chicago Bears. This includes two live football games involving the Chicago Bears, a replay of one of the games, and a highlight reel regarding the 1985 Chicago Bears football team. In other scenarios, the user 108 may desire a subset of the television events illustrated in Table #2. For example, the user 108 may desire to identify only live football games responsive to their search.

To accommodate these types of user search requests, the processor 206 is operable in at least one embodiment to apply multiple types of filters to the intermediate search results. For example, football games are typically broadcast on Sunday afternoons, Sunday evenings and Monday evenings. Thus, a filter for football programming may exclude television events that are not shown on Sundays and Mondays. Applying this filter to the intermediate search results of Table #1 results in the final search results of Table #3.

TABLE #3
Final search results

| Television Event | Channel | Date | Time |
|---|---|---|---|
| Chicago Bears at Detroit Lions | NBC | Sun-14 | 2:15 P.M. |
| NFL - Vikings at Bears | ESPN | Sun-21 | 7:00 P.M. |
| Bears Rap-Up with Coach XXX. | Local NBC | Mon-15 | 10:00 PM |

As illustrated in Table #3, the final search results include the television events of the live football games involving the Chicago Bears, and exclude the replay of the Chicago Bears at Detroit Lions game and the highlight show regarding the 1985 Chicago Bears football team. Other filters may also be applied to the intermediate search results to obtain the same or similar final search results. For example, football programming typically follows a pre-defined schedule, and games are broadcast at specific times of the day each week. A time based filter may indicate that live football games are expected to be broadcast during the afternoon and primetime hours on specific dates. Application of the channel filter and the time filter to the intermediate search results of Table #1 may result in the final search results illustrated in Table #3, as the other Chicago Bears programming illustrated in Table #2 falls outside of the broadcast times indicated by the time filter. Because sporting events are typically longer than other non-game related events, a duration filter may be used to differentiate both types of content. Application of a duration filter may filter out non-game related content like “Bears Rap-Up with Coach XXX” illustrated in tables 2 and 3.

In at least one embodiment, the processor 206 is operable to record television events associated with the final search results. For example, the processor 206 may automatically set recording timers associated with the final search results. In at least one embodiment, the processor 206 may output the final search results with input fields that allow the user 108 to designate particular television events for recording.

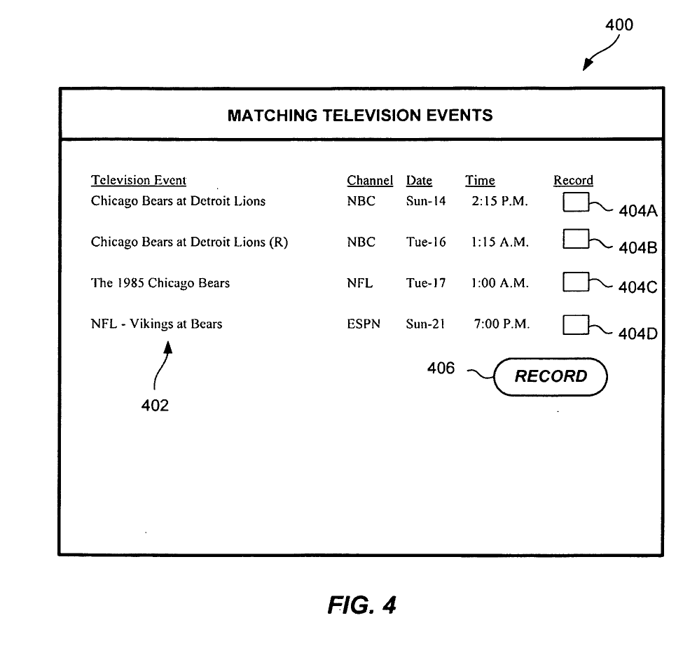

FIG. 4 illustrates a screenshot of an embodiment of a search result menu 400. More particularly, the search result menu 400 illustrates the final search results of Table #2. The search result menu 400 includes the search results 402, with each of the television events in the search results 402 being associated with one of the checkboxes 404A-404D. To designate a television event for recording, the user 108 activates the associated checkbox 404A-404D and actuates the record button 406. The processor 206 sets a recording timer for the indicated television event responsive to the user input and records the event at the time designated by the recording timer.

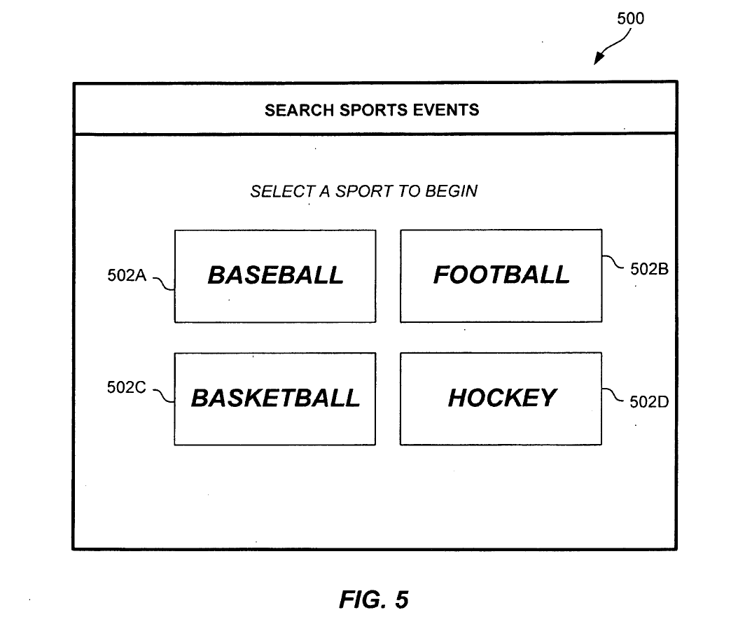

As illustrated in FIG. 3, a user 108 may input search criteria manually via the search menu 300. However, in at least one embodiment, the user 108 may provide search criteria through a pre-defined menu of sports teams. The user 108 may then provide user input selecting one of the sports teams, and the processor 206 identifies a search keyword and filters based on the selected sports team. FIG. 5 illustrates a screenshot of an embodiment of a sport selection menu 500 outputted by the television receiver 102A of FIG. 2. The user 108 initiates a search by selecting one of the buttons 502A-502D corresponding with the sport of the team upon which they desire to search. For example, the user 108 may press the button 502A indicating that they desire to search television content related to baseball teams.

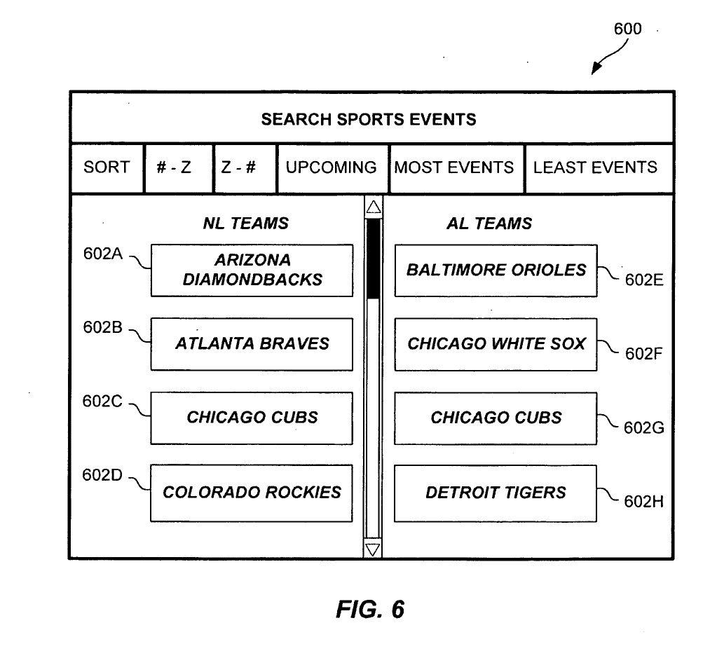

Responsive to the selection of the button 502A, the processor 206 outputs a menu including baseball teams searchable within the electronic programming guide. FIG. 6 illustrates a screenshot of an embodiment of a team selection menu 600 outputted by the television receiver 102A of FIG. 2. The user 108 locates a specified team and presses the corresponding button 602A-602H to proceed with the search for the team. For example, the user 108 may press button 602H to search for television events associated with the Detroit Tigers baseball team. The processor 206 operates to identify a search keyword and filters based on the selected sports team.

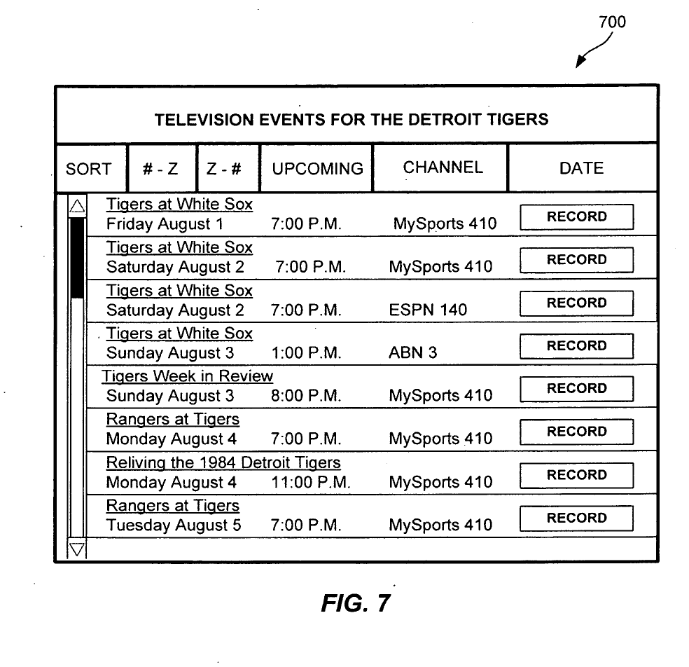

For example, in the illustrated embodiment, the processor 206 may identify the search keyword “Tigers”. The processor 206 responsively operates to locate television events in the electronic programming guide that correspond with the keyword “Tigers”. The processor 206 may then identify and apply various filters which are appropriate for baseball programming, such as the previously discussed channel, date, time and duration filters appropriate for baseball programming, to generate final search results. FIG. 7 illustrates a screenshot of an embodiment of a search result menu 700 outputted by the television receiver 102A of FIG. 2. As illustrated in FIG. 7, the user 108 may provide input to record particular television events listed in the search results. In other embodiments, the processor 206 may automatically set recording timers for the events in the search results, and absent user input to the contrary, may automatically record the identified events.

In some situations, the processor 206 may identify multiple television events related to the same game. For example, as illustrated in FIG. 7, the Tigers at White Sox game on Saturday August 2^{nd} is shown on two different channels simultaneously. In some situations, it may not be desirable to record both versions of the same game. In at least one embodiment, the processor 206 is operable to identify duplicate television events of the same game and responsively record one of the television events related to the game rather than multiple events. For example, the processor 206 may identify the two television events on August 2, and based on the titles, descriptions, dates, starting times and/or other information may determine that the television events are related to the same game. Thus, the processor 206 may decide to record the game on the MySports channel rather than the ESPN channel.

In at least one embodiment, the processor 206 applies priority rules to determine which television event to record. For example, the user 108 may prefer the coverage from ESPN rather than MySports, and may provide a priority input to the television receiver 102A. Thus, responsive to identifying duplicate or similar television events, the processor 206 applies the priority rules to set recording timers for one of the events and subsequently records the chosen event.

In some situations, games may be re-broadcast at a later date. For example, a baseball game may be broadcast live at 7:00 P.M., and may be re-broadcast again at 2:00 A.M. In at least one embodiment, the processor 206 is operable to identify re-broadcasted television events, and does not record the re-broadcasted event if another version has already been recorded. For example, the electronic programming guide data of the re-broadcasted television event may include a re-run flag, indicating that the television event is a replay of a previous event. In some embodiments, the processor 206 may compare other information, such as the title, description, program, episode ID and the like to determine whether two different television events include the same or similar content or otherwise involve the same game.

In at least one embodiment, the electronic programming guide data may include markers indicating that particular television events are related to sports programming. More particularly, the electronic programming guide data may include a marker indicating that particular television events are related to a game. The processor 206 may use this information during the searching and/or filtering process to include or exclude television events from the search results. For example, a particular television event may include a sports game marker and the keyword “Tigers”. Thus, the television event may be included in the search results for Detroit Tigers.

In at least one embodiment, the game markers may be used in place of the previously mentioned filters, e.g., channels, times, dates and the like. For example, a keyword search may be performed using at least a portion of the name of a team, and television events including the keyword may be filtered based on whether each television event includes a sports marker. In other words, television events that do not include the sports marker may be excluded from the final search results.

In other embodiments, the game markers may be used to augment other search filters. For example, search filters may be applied to identify programming on specific channels that carry sports programming, e.g., NBC, ABC, ESPN, regional sports networks and the like. However, a particular television event of a sports game may be broadcast on a channel that doesn't normally carry sports programming. If that particular television event includes a sports marker, then the television event may be included in the final search results even though it doesn't fit the criteria of the other search filters.

A team's schedule may also be utilized to augment or otherwise identify television events involving that particular team. The team's schedule indicates when the team is scheduled to play on particular dates. This information may be compared with television events identified based on a keyword search of the team's name (or any portion thereof) to determine whether the team plays on that particular date and/or time. For example, Table #4 illustrates an embodiment of a partial team schedule for the Texas Rangers baseball team.

TABLE #4
Exemplary embodiment of team schedule

| Game | Date | Time |
|---|---|---|
| Rangers at Tigers | Mon Aug 4 | 7:00 P.M. |
| Rangers at Tigers | Tues Aug 5 | 7:00 P.M. |
| Rangers at Tigers | Thu Aug 7 | 1:00 P.M. |
| Rangers at White Sox | Fri Aug 8 | 7:00 P.M. |
| Rangers at White Sox | Sat Aug 9 | 1:00 P.M. |
| Rangers at White Sox | Sun Aug 10 | 1:00 P.M. |

The processor 206 may perform a keyword search of the electronic programming guide to identify television events matching a keyword for the Texas Rangers. For example, the processor 206 may identify the search keyword “ranger” based on the team name Texas Rangers. Table #5 illustrates an embodiment of intermediate search results identified in the electronic programming guide related to the keyword “ranger”.

TABLE #5
Intermediate search results for “ranger”

| Television Event | Channel | Date | Time |
|---|---|---|---|
| The Lone Ranger | 2 | Mon 8/2 | 12:00 P.M. |
| Rangers at Tigers | 33 | Mon 8/4 | 7:00 P.M. |
| The Power Rangers | 5 | Tues 8/6 | 7:00 P.M. |
| Rangers at Tigers | 33 | Wed 8/4 | 12:30 P.M. |
| Walker Texas Ranger | 13 | Wed 8/6 | 7:00 P.M. |
| Walker Texas Ranger | 13 | Thu 8/7 | 7:00 P.M. |
| Rangers at White Sox | 13 | Fri 8/8 | 7:00 P.M. |
| The Lone Ranger | 2 | Sat 8/9 | 12:00 P.M. |
| Rangers at White Sox | 13 | Sat 8/9 | 1:00 P.M. |

The processor 206 may utilize the team schedule in Table #4 as at least one filter to narrow the intermediate search results in Table #5. For example, the processor 206 may compare each record of the intermediate search results to determine whether the Texas Rangers have a scheduled game on that particular time and/or date. In Table #5, the first record corresponds with a television event broadcast on Monday 8/2 at 12:00 P.M. The team schedule indicates that the Rangers are scheduled to play that same day at 7:00 P.M., seven hours after the broadcast of the Lone Ranger. Thus, it is unlikely that the Lone Ranger television event is related to a game involving the Texas Rangers, and the processor 206 may responsively remove the television event from the search results.

The second record of the intermediate search results directly corresponds with the date and time of a scheduled Texas Rangers game. Thus, there is some likelihood that the television event corresponds with the Texas Rangers team. In at least one embodiment, the processor 206 decides to include the identified television event based on matching the date and time of the television event with a scheduled Texas Rangers baseball game.

In at least one embodiment, the processor 206 may apply further filters to determine whether the television event is actually related to a televised Texas Rangers baseball game. For example, a channel filter may be utilized to determine whether the Monday August 4 Rangers at Tigers television event is being broadcast on a channel that typically broadcasts Texas Rangers' baseball games. Thus, if the filter indicates that channel 33 typically broadcasts sports programming, then the Rangers at Tigers television event on Monday August 4 will be included in the final search results identified by the processor 206.

A similar process may be performed for the Power Rangers television event broadcast on Tuesday August 5 at 7:00 P.M. on channel 5. This particular television event is being broadcast at the same time as a scheduled Texas Rangers baseball game. Thus, the television event passes the first filter. However, a subsequent channel filter maybe applied to this event. Thus, if channel 5 does not typically show sports programming, then the processor 206 may determine that the television event is likely unrelated to the Texas Rangers baseball team, and exclude the television event from the final search results.

Next, the processor 206 processes the Rangers at Tigers television event broadcast on Wednesday 8/4 at 12:30 P.M. on channel 33. An initial comparison to the team schedule shows that the television event starts at a different time than a scheduled Texas Rangers baseball game. However, the scheduled time is in close proximity and otherwise overlaps the scheduled baseball game on that date. Thus, the processor 206 may decide to initially leave this television event in the search results and apply subsequent filters, such as the channel filter, to determine whether to exclude this television event from the search results. Similar filtering operations may be performed on the other television events in the intermediate search results of Table #5 to identify the final search results presented to the user 108. Table #6 illustrates one embodiment of final search results generated from the intermediate search results of Table #5 based on using a comparison of the television events to the sport schedule and other filtering techniques as described herein.

TABLE #6
Final search results for “Texas Rangers”

| Television Event | Channel | Date | Time |
|---|---|---|---|
| Rangers at Tigers | 33 | Mon 8/4 | 7:00 P.M. |
| Rangers at Tigers | 33 | Wed 8/4 | 12:30 P.M. |
| Rangers at White Sox | 13 | Fri 8/8 | 7:00 P.M. |
| Rangers at White Sox | 13 | Sat 8/9 | 1:00 P.M. |

In some situations, the user 108 may desire to view search results including either television events associated with games involving a sports team or other non-game sports content, referred to herein as commentary, related to the sports team. As used herein, commentary refers to any type of television event that does not correspond to a sports game, such as pre-game or post-game shows, interviews, news shows, highlights, talk shows and the like. The teachings described herein may be applied to separate, sort or otherwise filter television content related to a particular sports team into multiple groups. The separation may be performed based on analysis of either the descriptive program information related to the television events identified in the final search results, the non-descriptive program information identified in the final search results or any combination thereof.

For example, certain television channels may be known for carrying commentary regarding sports, but don't typically carry live events regarding certain teams or sports. Thus, channel filters may be applied to separate game content from commentary. Time filters may also be utilized to separate game content from commentary. For example, sports content that is broadcast early in the morning is likely a talk show or other type sports commentary. In at least one embodiment, duration filters may be utilized to differentiate game content from commentary. For example, sports content is typically longer (e.g., 2-3 hours) than a talk show or other type sports commentary (typically 30 minutes-1 hour). Similarly, a block of content involving a team that is broadcast before that scheduled start time of a game is likely commentary rather than game content. For example, a television event regarding a football team that is broadcast from 12:00 P.M. to 1:00 P.M. before a scheduled 1:00 P.M. game is likely commentary, and the processor 206 may likely group the television event broadcast at 12:00 P.M. into the commentary group.

In at least one embodiment, the processor 206 outputs a search result menu that includes all of the content related to a team, and that further includes buttons or other input fields that allow the user 108 to request to view subsets of the identified content, such as game content only, commentary content only or only specific types of commentary content (e.g., post game shows). Thus, responsive to the user 108 selecting one of the buttons, the processor 206 may operate to output another search result menu including the group of sports content requested by the user 108. In at least one embodiment, the different groups of television events may be outputted by the processor 206 for display with visual indicators indicating the particular group of content associated with the television event. For example, a first visual indicator may highlight game content and a second visual indicator may highlight commentary content.

Those of ordinary skill in the art will appreciate that the various functional elements 202 through 208 shown as operable within the television receiver 102A may be combined into fewer discrete elements or may be broken up into a larger number of discrete functional elements as a matter of design choice. Thus, the particular functional decomposition suggested by FIG. 2 is intended merely as exemplary of one possible functional decomposition of elements within the television receiver 102A.

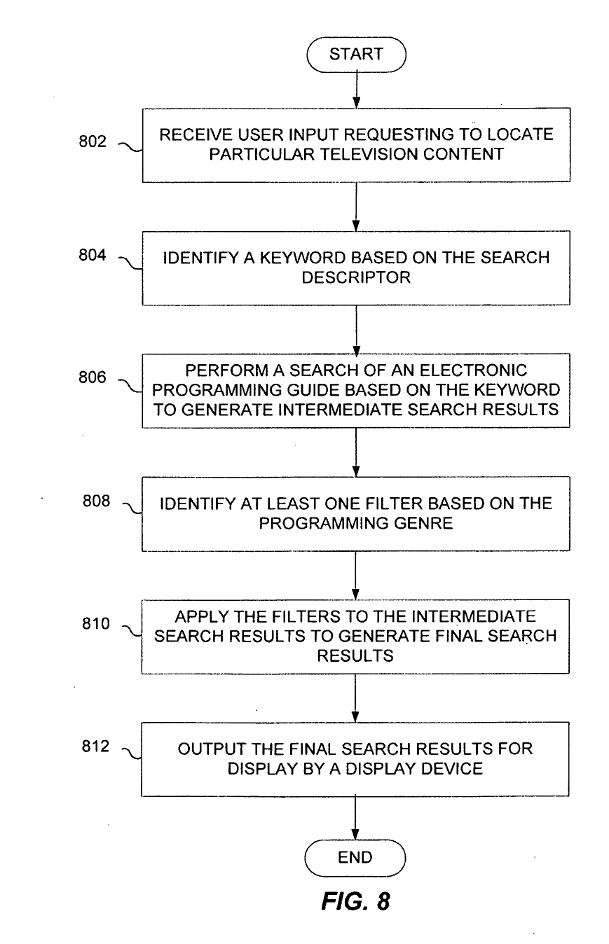

FIG. 8 illustrates an embodiment of a process for locating television content. More particularly, the process of FIG. 8 operates to locate particular television content related to both a search descriptor and a genre provided by a user. The process of FIG. 8 may include other operations not illustrated for the sake of brevity.

The process includes receiving user input requesting to locate particular television content (operation 802). More particularly, the user input indicates a search descriptor for the particular television content and a genre of the particular television content. The user may provide the search descriptor and the genre separately through any type of search user interface, or the search genre may be implied based on a particular search user interface that the user utilizes to input the search descriptor. For example, the user may have a choice of multiple search menus, some of which may be utilized to search for sports programming or children's programming. By selecting which user interface to utilize, the user impliedly indicates the search genre for utilization by the television receiver.

The process further includes identifying a keyword based on the search descriptor (operation 804). In at least one embodiment, the keyword and the search descriptor may be the same. In other embodiments, the keyword may comprise a portion of the search descriptor. For example, the search descriptor may comprise the team name Chicago Bears, and the keyword may comprise “Bears”. In at least one embodiment, the search descriptor may be utilized to identify a related search keyword. For example, the search descriptor “Chicago Football” may be utilized to identify the search keyword “Bears”.

The process further includes performing a search of an electronic programming guide based on the keyword to generate intermediate search results including television events listed in the electronic programming guide (operation 806). In at least one embodiment, operation 806 may include searching descriptive programming information of the electronic programming guide, such as titles, descriptions and other metadata describing the substance of the television content.

The process further includes identifying at least one filter based on the programming genre (operation 808). For example, identified filters may include expected broadcast times, expected broadcast dates, expected broadcast channels or any combination thereof for the content associated with the genre.

The process further includes applying the filters to the intermediate search results to generate the final search results (operation 810). More particularly, operation 810 may include checking each record of the intermediate search results to determine whether the television event associated with the record matches the criteria specified by one or more filters. In at least one embodiment, the filters may be applied to non-descriptive program information associated with the television events of the intermediate search results.

The process further includes outputting the final search results for display by a display device (operation 812). The process may optionally include setting a recording timer associated with a television event included in the final search results and recording the television event responsive to the recording timer.

Although specific embodiments were described herein, the scope of the invention is not limited to those specific embodiments. The scope of the invention is defined by the following claims and any equivalents therein.

What is claimed:

1. A method of locating television content, the method comprising:
receiving user input requesting to locate particular television content, the user input indicating a search descriptor of the particular television content and a programming genre of the particular television content;
identifying a keyword based on the search descriptor;
performing a search of an electronic programming guide based on the keyword to generate intermediate search results including television events listed in the electronic programming guide;
identifying at least one filter based on the programming genre;
applying the filter to the intermediate search results to generate final search results; and
outputting the final search results for display by a display device.

2. The method of claim 1, wherein performing the search of the electronic programming guide and applying the filter further comprise:
searching descriptive program information of the electronic programming guide, based on the keyword, to generate the intermediate search results; and
applying the filter to non-descriptive program information associated with the television events included in the intermediate search results to generate the final search results.

3. The method of claim 2, wherein the non-descriptive program information includes a broadcast time of the television events, and wherein identifying the filter and applying the filter further comprise:
identifying expected broadcast times for the particular television content associated with the programming genre; and
determining whether the television events of the intermediate search results correspond with at least one of the expected broadcast times, the final search results being comprised of a portion of the television events of the intermediate search results that correspond with the at least one of the expected broadcast times.

4. The method of claim 2, wherein the non-descriptive program information includes a broadcast channel of the television events, and wherein identifying the filter and applying the filter further comprise:
identifying expected broadcast channels for the particular television content associated with the programming genre; and
determining whether the television events of the intermediate search results correspond with at least one of the expected broadcast channels, the final search results being comprised of a portion of the television events of the intermediate search results that correspond with the at least one of the expected broadcast channels.

5. The method of claim 2, further comprising:
setting a recording timer associated with at least one television event included in the final search results; and
recording the television event responsive to the recording timer.

6. The method of claim 2, wherein the user input requests to locate the television content associated with a selected sports team.

7. The method of claim 6, wherein the non-descriptive program information includes a broadcast channel, a broadcast time and a broadcast date of the television events associated with the sports team, and wherein identifying the filter and applying the filter further comprise:
identifying expected broadcast channels of the television content associated with the sports team;
identifying expected broadcast times of the television content associated with the sports team;
identifying expected broadcast dates of the television content associated with the sports team; and
identifying the television events of the intermediate search results that correspond with at least one of the expected broadcast channels, at least one of the expected broadcast times and at least one of the expected broadcast dates for the television content involving the sports team to generate final search results.

8. The method of claim 7 wherein identifying the filter and applying the filter further comprise:
identifying expected broadcast durations of the television content associated with the sports team.

9. The method of claim 7, further comprising:
identifying a first group of the television events of the final search results, associated with games involving the sports team, based on the descriptive program information and the non-descriptive program information associated with the television events of the final search results;
identifying a second group of the television events of the final search results, associated with commentary regarding the sports team, based on the descriptive program information and the non-descriptive program information associated with the television events of the final search results;
receiving second user input requesting to view the games involving the sports team; and
outputting the first group of the television events for display by the display device responsive to the second user input.

10. A method for locating sports television content, the method comprising:
receiving user input requesting to locate television content associated with a particular sports team;
identifying a search keyword based on the user input, the search keyword including at least a portion of a team name of the sports team;
searching descriptive program information of an electronic programming guide based on the keyword to generate intermediate search results including television events;
identifying at least one filter based on a sport of the sports team;
applying the filter to non-descriptive program information of the intermediate search results to generate final search results; and
outputting the final search results for display by a display device.

11. The method of claim 10, wherein the descriptive program information of the electronic programming guide includes program titles of television content included in the electronic programming guide.

12. The method of claim 10, wherein the non-descriptive program information includes a broadcast time of the television events, and wherein identifying the filter and applying the filter further comprise:
identifying expected broadcast times for games involving the sports team; and
determining whether the television events of the intermediate search results correspond with at least one of the expected broadcast times, the final search results being comprised of a portion of the television events of the intermediate search results that correspond with the at least one of the expected broadcast times.

13. The method of claim 10, wherein the non-descriptive program information includes a broadcast channel of the television events, and wherein identifying the filter and applying the filter further comprise:
identifying expected broadcast channels for games involving the sports team; and
determining whether the television events of the intermediate search results correspond with at least one of the expected broadcast channels, the final search results being comprised of a portion of the television events of the intermediate search results that correspond with the at least one of the expected broadcast channels.

14. The method of claim 10, wherein applying the filter to the non-descriptive program information further comprises:
identifying at least a portion of the intermediate search results that include a marker indicating that the associated television content comprises a sporting event; and
generating the final search results based on the identified portion of the intermediate search results.

15. The method of claim 10, further comprising:
setting at least one recording timer for the television content associated with the final search results.

16. The method of claim 10, further comprising:
identifying that the final search results include at least two separate television events associated with the same game involving the sports team on two different channels;
identifying a recording priority for a first of the two separate events associated with the same game, the recording priority associated with a particular channel broadcasting the first event; and
setting the at least one recording timer for the first event.

17. The method of claim 10, further comprising:
identifying that the final search results include a first television event associated with a first broadcast of a game at a first time and a second television event associated with a second broadcast of the game at a second time;
selecting one of the first broadcast and the second broadcast for recording; and
setting a recording timer for the selected one of the first broadcast and the second broadcast.

18. The method of claim 10, wherein receiving the user input, identifying the keyword and identifying the filter further comprise:
outputting a selection menu comprised of a plurality of sports teams;
receiving the user input selecting one of the plurality of sports teams;
identifying the keyword based on the selected one of the plurality of sports teams; and
identifying the filter based on the selected one of the plurality of sports teams.

19. A television receiver comprising:
a network interface that receives electronic programming guide data from a content source;
an input interface that receives user input requesting to locate particular television content, the user input indicating a search descriptor of the particular television content and a programming genre of the particular television content; and
a processor communicatively coupled to the network interface and the input interface operable to:
identify a keyword based on the search descriptor;
perform a search of an electronic programming guide based on the keyword to generate intermediate search results including television events listed in the electronic programming guide;
identify at least one filter based on the programming genre;
apply the filter to the intermediate search results to generate final search results; and
output a search result menu, including the final search results, for display by a display device.

20. The television receiver of claim 19, wherein the processor is operable to:
search descriptive program information of the electronic programming guide, based on the keyword, to generate the intermediate search results; and
apply the filter to non-descriptive program information associated with the television events included in the intermediate search results to generate the final search results.

21. The television receiver of claim 20, wherein the non-descriptive program information includes a broadcast time of the television events, and the processor is further operable to:
identify expected broadcast times for the particular television content associated with the programming genre; and
determine whether the television events of the intermediate search results correspond with at least one of the expected broadcast times, the final search results being comprised of a portion of the television events of the intermediate search results that correspond with the at least one of the expected broadcast times.

22. The television receiver of claim 20, wherein the non-descriptive program information includes a broadcast channel of the television events, and wherein the processor is further operable to:
identify expected broadcast channels for the particular television content associated with the programming genre; and
determine whether the television events of the intermediate search results correspond with at least one of the expected broadcast channels, the final search results being comprised of a portion of the television events of the intermediate search results that correspond with the at least one of the expected broadcast channels.

23. The television receiver of claim 20, further comprising:
a storage medium;
wherein the processor is further operable to set a recording timer associated with at least one television event included in the final search results and coordinate storage of video signals associated with the at least one television event responsive to the recording timer.

24. The television receiver of claim 20, wherein the user input requests to locate the television content associated with a selected sports team.

25. The television receiver of claim 24, wherein the non-descriptive program information includes a broadcast channel, a broadcast time and a broadcast date of the television events associated with the sports team, and wherein the processor is further operable to:
identify expected broadcast channels of the television content associated with the sports team;
identify expected broadcast times of the television content associated with the sports team;
identify expected broadcast dates of the television content associated with the sports team; and
identify the television events of the intermediate search results that correspond with at least one of the expected broadcast channels, at least one of the expected broadcast times and at least one of the expected broadcast dates for the television content involving the sports team to generate the final search results.

26. The television receiver of claim 25, wherein the processor is further operable to identify expected broadcast durations of the television content associated with the sports team.

27. The television receiver of claim 25, wherein the processor is further operable to:
identify a first group of the television events of the final search results, associated with games involving the sports team, based on the descriptive program information and the non-descriptive program information associated with the television events of the final search results;
identify a second group of the television events of the final search results, associated with commentary regarding the sports team, based on the descriptive program information and the non-descriptive program information associated with the television events of the final search results; and
output a display menu including the television events for display by the display device, the display menu including visual indicators to distinguish the first group of the television events from the second group of the television events.

28. A television receiver comprising:
a network interface that receives electronic programming guide data from a content source;
an input interface that receives user input requesting to locate television content associated with a particular sports team; and
a processor communicatively coupled to the network interface and the input interface operable to:
identify a search keyword based on the user input, the search keyword including at least a portion of a team name of the sports team;
search descriptive program information of an electronic programming guide based on the keyword to generate intermediate search results including television events;
identify at least one filter based on a sport of the sports team;
apply the filter to non-descriptive program information of the intermediate search results to generate final search results; and
output a search result menu, including the final search results, for display by a display device.

29. The television receiver of claim 28, wherein the descriptive program information of the electronic programming guide includes program titles of television content included in the electronic programming guide.

30. The television receiver of claim 28, wherein the non-descriptive program information includes a broadcast time of the television events, and wherein the processor is further operable to:
identify expected broadcast times for games involving the sports team; and
determine whether the television events of the intermediate search results correspond with at least one of the expected broadcast times, the final search results being comprised of a portion of the television events of the intermediate search results that correspond with the at least one of the expected broadcast times.

31. The television receiver of claim 28, wherein the non-descriptive program information includes a broadcast channel of the television events, and wherein the processor is further operable to:
identify expected broadcast channels for games involving the sports team; and
determine whether the television events of the intermediate search results correspond with at least one of the expected broadcast channels, the final search results being comprised of a portion of the television events of the intermediate search results that correspond with the at least one of the expected broadcast channels.

32. The television receiver of claim 28, wherein the processor is further operable to:
identify at least a portion of the intermediate search results that include a marker indicating that the associated television content comprises a sporting event; and
generate the final search results based on the identified portion of the intermediate search results.

33. The television receiver of claim 28, wherein the processor is further operable to set at least one recording timer for the television content associated with the final search results.

34. The television receiver of claim 28, wherein the processor is further operable to:
identify that the final search results include at least two separate television events associated with the same game involving the sports team on two different channels;
identify a recording priority for a first of the two separate events associated with the same game, the recording priority associated with a particular channel broadcasting the first event; and
set the at least one recording timer for the first event.

35. The television receiver of claim 28, wherein the processor is further operable to:
identify that the final search results include a first television event associated with a first broadcast of a game at a first time and a second television event associated with a second broadcast of the game at a second time;
select one of the first broadcast and the second broadcast for recording; and
set a recording timer for the selected one of the first broadcast and the second broadcast.

36. The television receiver of claim 28, wherein the processor is further operable to:
output a selection menu comprised of a plurality of sports teams;
receive the user input selecting one of the plurality of sports teams;
identify the keyword based on the selected one of the plurality of sports teams; and
identify the filter based on the selected one of the plurality of sports teams.
